(19) United States
(12) Patent Application Publication
(10) Pub. No.: US 2003/0191936 A1
(43) Pub. Date: Oct. 9, 2003

(54) Access control method and system

(76) Inventors: Yoshiaki Kawatsura, Kawasaki (JP); Hiroyuki Chiba, Kawasaki (JP); Kiyoshi Watanabe, Tokyo (JP); Akira Morita, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/217,454

(22) Filed: Aug. 14, 2002

(30) Foreign Application Priority Data
Apr. 8, 2002 (JP) 2002-104648

(51) Int. Cl. H04L 9/00

(52) U.S. Cl. 713/156; 705/59

(57) ABSTRACT

An access control method used in a client connected to a server. The method manages a certification authority certificate used to judge whether the server has right to access the client. The certification authority certificate is made into a usable state under a predetermined condition. When accessing the server, the client receives a certificate specifying the server transmitted from the server. When a certification authority certificate corresponding to the certificate specifying the server exists in a usable state, access to the server is enables in accordance with a comparison result.

### BACKGROUND OF THE INVENTION

The present invention relates to an access control method and system and in particular, to a method and an apparatus for performing access control to a service provider system at a service user side in accordance with a service or the like provided by a service provider side.

When a general-purpose client system working in cooperation with a server side to which the client system is connected via a network can use a service provided by the server side, this service use may be limited by either of the following two types: a use limit to the general-purpose client system itself which is realized by applying upon shipment of a general-purpose client system, a use limit function to application software used in the general-purpose client system and fetching a license upon use of the software, so that the limit is released at the general-purpose client system side; and a server management method in which a server side controls server access authority of the general-purpose client system, thereby limiting use of a service provided by the server.

In case of the method of use limit to the general-purpose client system itself, when using a service provided by the server side, a release key is received from a license server to release the limit and installed in the general-purpose client system, so that the service can be used. Moreover, in case of the server management method, the server side has license information (password or the like) of the general-purpose client system and upon use of a service via the client system, the license information is verified before the service can be used.

### SUMMARY OF THE INVENTION

However, in the method of use limit to the general-purpose client system itself, since the client system is a general-purpose system, when the server side wants to apply a use limit for each of the services provided by the server side, a list of services whose use is to be limited should be managed by the client system. Moreover, when the server side wants to provide a new service with use limit, the server cannot add it at once. In the server management method, when a password sent from a general-purpose client system is used to judge whether the general-purpose client system can use a service, the server side should have a system for managing passwords.

Here, for security to exclude eavesdrop and the like when receiving a service on the Internet, there is a method to assure a safe communication path by using the standard specification such as an SSL (secure socket layer) and a TLS (transport layer security). The current WWW server and the WWW browser contain certification authority certificates (certification authority information including a certification authority public key and self-signed with a secret key of the certification authority) of a plurality of predetermined certification authorities. When a server or a client gets a communication path, the server or the client uses this certification authority certificate so as to verify whether a certificate (client certificate, server certificate) transmitted from a communication mate has been issued from a reliable certification authority, thereby performing access control. However, the current certification authority certificate has its main purpose to perform authentication for assuring a safe communication path and there is no scheme for issuing a certification authority certificate in accordance with the service use limit and other condition, i.e., no use scheme has been established.

It should be noted that a client certificate is normally issued after an examination on client basis in a certification authority and a user who wants to use a new service should send a client public key, address, and other personal information to the certification authority.

An object of the present invention is to provide a method and a system capable of performing access control to a service provider side at a service user side.

Another object of the present invention is to provide a method and a system capable of flexibly performing a use limit for each service.

To achieve the aforementioned objects, in the present invention, a use limit is added to the information used for judging whether an access authority is present (certification authority certificate including a root certificate), so that only a usable certification authority certificate is used for a certificate verification (verification performed when establishing a safe transmission path by the SSL and the like), thereby performing access control. Moreover, license management is performed in such a manner that license information is added to a certification authority certificate or the like, so that the license information is used to limit use of the certification authority certificate and a usable service can be added when required.

More specifically, a system (first system) to be accessed such as a service provider system (server system and the like is connected via a network to a system (second system) to access something such as a service user system (client system and the like). An access control method for accessing the first system is realized by management of first information (certification authority certificate including a root certificate and the like) used for judging whether the first system has an access authority to access the second system. The first information is made to a usable state by a predetermined condition and when accessing the first system, second information (a certificate or the like specifying the first system) transmitted from the first system is received. When the first information corresponding to the second information is present in a usable state, the first information is compared to the second information and accessing the first system is enabled in accordance with the comparison result. Here, the predetermined condition is information on use limit of the first information such as a valid period of the first information and information on a connection destination which can use the first information.

It should be noted that the aforementioned object may be achieved by a program realizing the aforementioned function or a recording medium containing the program.

Other objects, features and advantages of the invention will become apparent from the following description of the embodiments of the invention taken in conjunction with the accompanying drawings.

### BRIEF DESCRIPTION OF THE DRAWINGS

FIG. 1 shows a system configuration according to a first embodiment of the present invention.

FIG. 2 is a block diagram of the present invention applied to a client system according to one embodiment.

FIG. 3 shows data configuration of a token identification information storage area.

FIG. 4 shows data configuration of license information 900.

FIG. 5 shows data configuration of information in a temporary storage area of usable certification authority certificate information.

FIG. 6 is a block diagram showing license server configuration according to an embodiment.

FIG. 7 is a flowchart showing client system processing performed when license information is fetched.

FIG. 8 shows data configuration of a license information request message.

FIG. 9 is a flowchart showing license server processing performed when license information is fetched.

FIG. 10 is a flowchart showing client system processing performed after the license information is fetched.

FIG. 11 is a flowchart showing client system processing performed when license information is verified.

FIG. 12 is a flowchart showing processing performed when a client system service is used.

FIG. 13 is a flowchart of state monitoring about a use token in a usable information management block.

### DETAILED DESCRIPTION OF THE INVENTION

Description will now be directed to preferred embodiments with reference to attached drawings. It should be noted that the present invention is not to be limited to these embodiments.

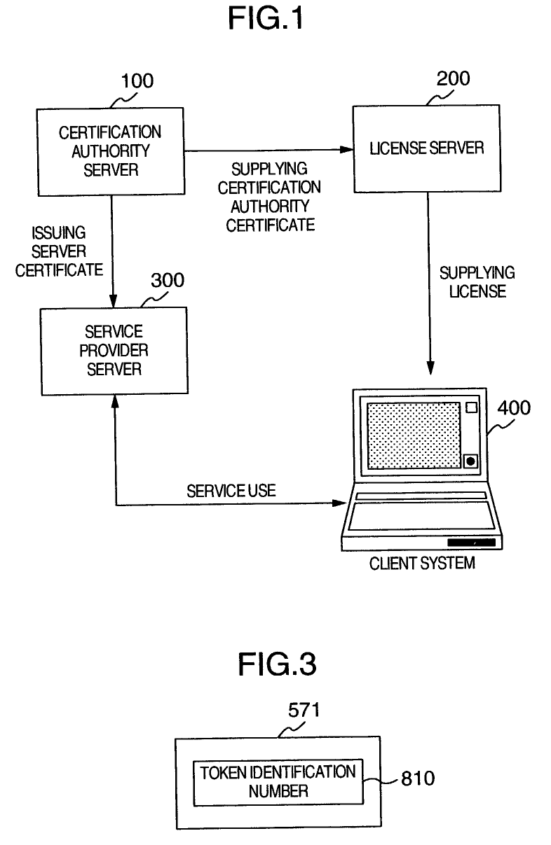

FIG. 1 shows system configuration according to an embodiment of the present invention. The system includes a certification authority server 100, a license server 200, a service provider server 300, and a client system 400 used by a service user. The servers do not necessarily have to a single independent function. For example, the certification authority server 100 and the license server 200 may be operated by the same subject. Connection between the servers and between the servers and the client system is established via a network such as Internet when required.

The certification authority server 100 has a certification authority certificate and a secret key constituting a pair with a public key stored in the certification authority certificate and provides the certification authority certificate via the license server 200 to the client system 400. The certification authority certificate according to the present invention is, for example, information to identify a certification authority such as a self-signed certificate prepared by self-signing with a self secret key and adding a public key to it. This information can be utilized for server certificate verification. The certification authority certificate according to the present invention may be one usable for the standard protocol SSL or other then this. When used together with the standard protocol SSL, the function of the SSL assures a safe communication path. Moreover, the certification authority certificate issues a digital certificate for a service provider (server certificate). The server certificate in the present invention is, for example, a digital certificate including a public key of a public key pair obtained by the service provider and having a digital signature with a secret key to be pair with the public key stored in the certification authority certificate, thereby specifying a service provider. Validity of a server certificate is verified by suing the public key attached to the certification authority certificate provided from the certification authority server 100. The service provider server 300 provides a service to a service user in accordance with access from the client system 400. The license server 200 provides license information allowing the service user to use the certification authority, so as to use a particular service at the client system 400. More preferably, the service user has a self-signed certificate prepared by self-signing with a his/her secret key and adding a public key and digitally signs the license information with a license server secret key and provides it. The client system 400 has an access control system for service use of the service provider 300.

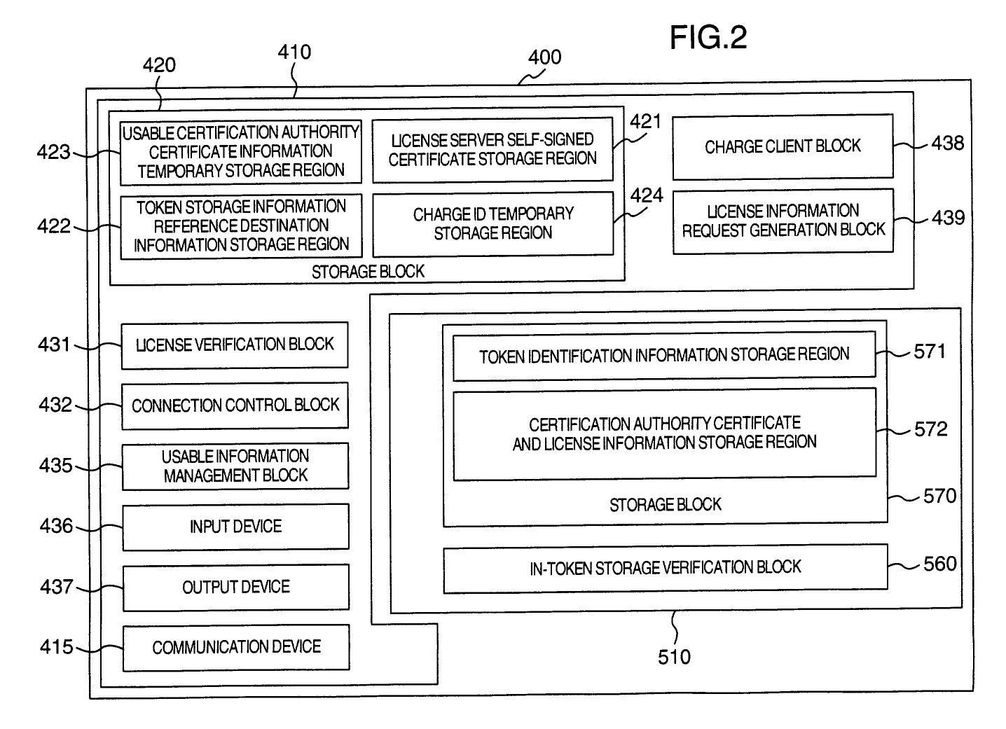

FIG. 2 is a block diagram showing configuration of the client system according to the present invention. The client system 400 includes a basic system 410 for performing license verification for using a service and a client use token 510 for managing a certification authority certificate used for using a service and license information related to it. The client use token 510 may be attached and detached to/from the basic system 410 and can be used, for example, via USB and PCMCIA.

The basic system 410 has a communication apparatus 415, a storage block 420, an input apparatus 436, an output apparatus 437, and a control block. The control block includes: a license verification block 431 for verifying validity of license information, a connection control block 432 for verifying a server certificate and performing access control, a usable information management block 435 for controlling management of usable certification authority certificates, a charge client block 438 for performing charge processing with the license server for supplying a license, and a license information request generation block 439 for generating a message for requesting for license information to the license server. The storage block 420 includes a license server self-signed digital certificate storage region for storing self-signed certificates, a token storage information reference destination information storage region 422 indicating a storage position of the certification authority certificate and the license information in the client use token 510, a usable certification authority certificate information temporary storage region 423 for utilizing a certification authority certificate related to license information whose validity has been verified, and a charge ID temporary storage region 424 for temporarily storing a charge ID as an identifier of charge completion received from the license server.

The client use token 510 has a storage block 570 and an in-token storage verification block 560 for storing license information for a particular token. The storage block 570 includes a token identification information storage region 571 containing information for uniquely identifying a token, and a certification authority certificate and license information storage region 572 for storing a certification authority certificate required for receiving a service from a service provider by using the basic system and license information for limiting use of the certification authority certificate.

It should be noted that the function of the present invention realized by the aforementioned client system 400 can also be provided as software. For example, a recording medium is provided to store a program for realizing a function of the license verification block 431 and the program is read into the client system 400 via a drive apparatus connected to the client system 400 or transferred to the client system 400 via the Internet, so as to be executed.

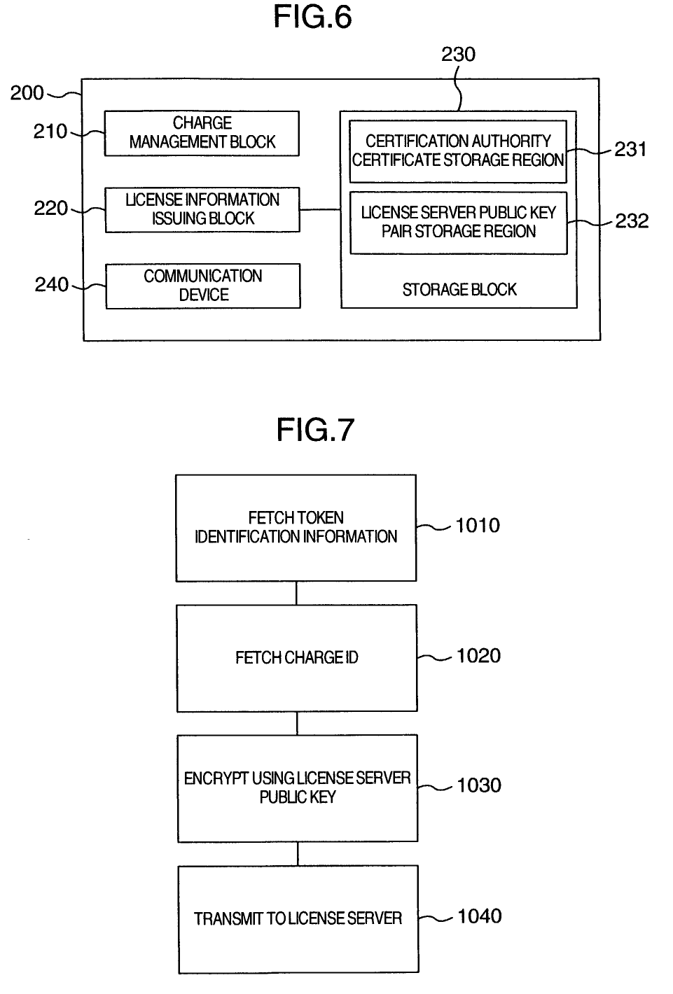

FIG. 6 is a block diagram showing configuration of the license server. The license server 200 provides a license to the client system 400 and performs charging management upon provision of a license. There are provided a charge management block 210 for issuing and managing a charge ID after charging from the client system 400, a license information issuing block 220 for checking validity of a license information request and generating license information, a storage block 230, and a communication apparatus 240. The storage block 230 includes a certification authority certificate storage region 231 for storing a certification authority certificate issued from the certification authority server 100 and a license server public key pair storage region 232 used when generating license information.

Hereinafter, explanation will be given on the processing of the client system 400 up to the license information fetch request transmission in the license information fetch method according to the present invention with reference to a flowchart of FIG. 7. When fetching license information of a service user, charge processing is completed between the license server 200 and the client system 400, and the license server 200 issues a charge ID indicating that the charging processing is complete to the client system 400. This charge ID is stored in the charge ID temporary storage region 424 in the client system 400. Moreover, a certification authority certificate for which license information is to be issued is also linked with a charge ID in the charge management block 210 in the license server 200.

The license information request generation block 439 fetches a token identification number (FIG. 3) uniquely identifying a token stored in the token identification information storage region 571 in the client use token 510 (step 1010), fetches a charge ID from the charge ID temporary storage region 424 (step 1020), generates a license information request message encrypted with a public key of the license server self-signed certificate stored in the license server self-signed certificate storage region 521 (step 1030) and transmits the license information request message via the communication apparatus 415 to the license server 200 (step 1040). It should be noted that step 1010 and step 1020 may be in a different order.

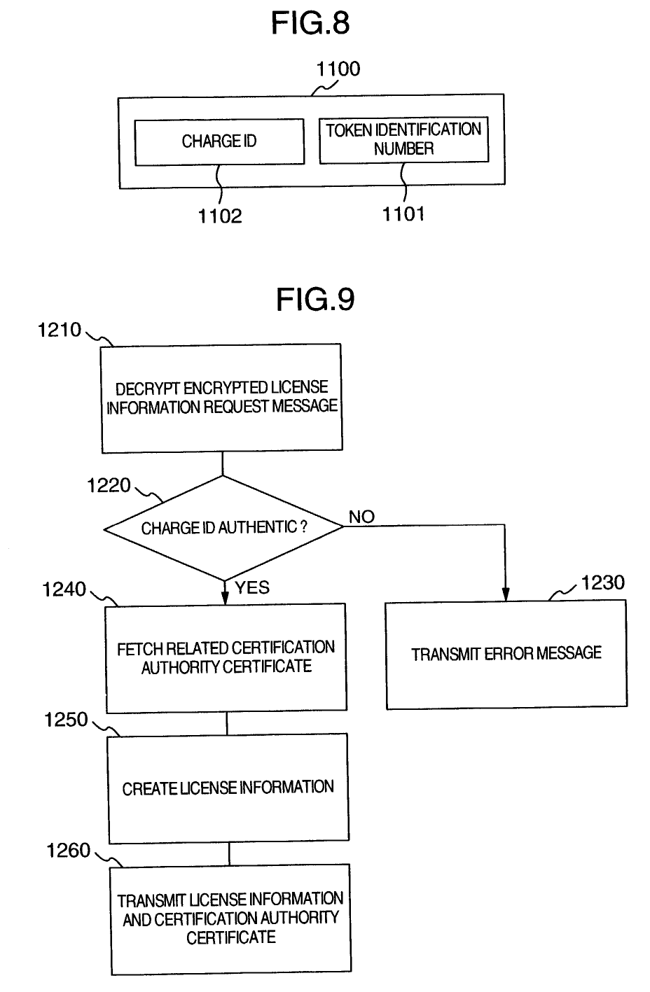

FIG. 8 shows data configuration of the license information request message 1100. The license request message 1100 contains a token identification number 1101 and a charge ID 1102 which are encrypted by a public key in the license server self certificate. Thus, by requesting for license information by adding a token identification number, a license can be offered and managed on client use token basis. As a result, even when the basis system 410 used by a user is not fixed, by carrying the client use token, it is possible to reduce the trouble of an authentic user to request for the certification authority certificate and the license information for each of the basic system 410. Moreover, when the basic system 410 is shared by a plurality of users, as will be detailed later, information in the basic system 410 is deleted in accordance with attachment and removal of a client use token, it is possible to prevent transparent use of a certification authority certificate and license information fetched by another user.

Next, explanation will be given on the processing of the license server 200 with reference to a flowchart of FIG. 9. The license information issuing block 220 receives a license information request message 1100, fetches a secret key constituting a pair with its public key in the license server self certificate from the license server public key pair storage region 231, decrypts the encrypted license information request message 1100 (step 1210), and checks whether the charge ID 1102 is valid in the charge management block 210 (step 1220). Unless the charge ID 1102 is valid, an error message indicating invalidity is transmitted to the client system 400 and the processing is terminated (step 1230). When the charge ID 1102 is found to be valid, license information is generated in the license information issuing block 220.

The license information issuing block 220 fetches from the certification authority certificate storage region 231, a certification authority certificate to which a license is to be given among the certification authority certificates issued by the certification authority server 100 (step 1240) and generates license information (step 1250). The license server 200 transmits the license information 900 to the client system 400 together with a related certification authority certificate (step 1260).

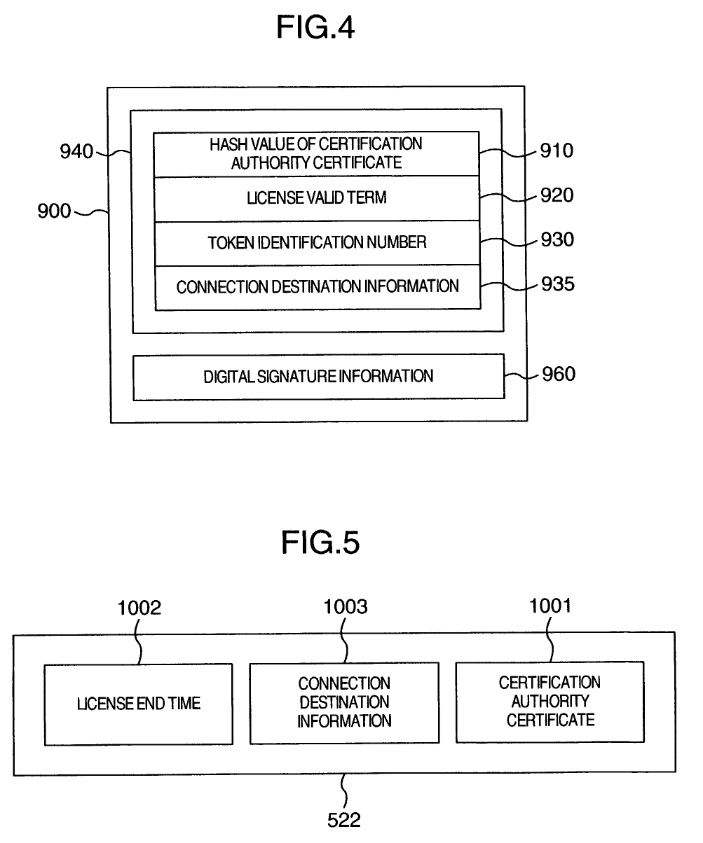

FIG. 4 shows data configuration of the license information 900. The license information 900 has a license basic information including a hash value 910 of a certification authority certificate to which a license is to be given, a license valid term 920 indicating a valid term during which the certification authority certificate can be used, and a token identification number 930, and digital signature information 960 signed with a server secret key added to the license basic information 940. It should be noted that connection destination information 935 may be added to the license basic information 940. When the connection destination information 935 is provided, it is possible to set a certification authority certificate use on connection destination basis/service basis. As the connection destination information, there are a method to describe an identifier such as an URL of a connectable destination and a method to describe an identifier of a destination which cannot be connected, and the method can be modified according to an embodiment.

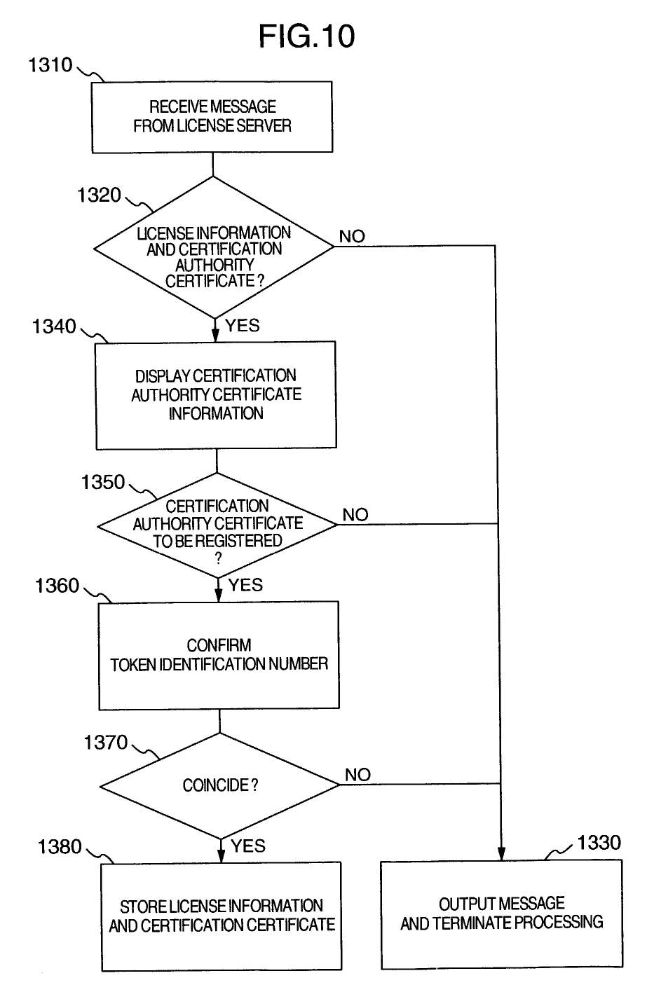

Next, explanation will be given on the processing of the client system 400 after the license information is received from the license server with reference to a flowchart of FIG. 10. The basic system 410 receives a message from the license server 200 (step 1310) and checks whether the message is an error message or license information (step 1320). If the message is an error message, the error message is displayed on the output apparatus 437 and the processing is terminated (step 1330). If the message is license information and certification authority certificate, a content of the certification authority certificate is displayed on the output apparatus 437 (step 1330), and check is made whether it is registered in the client use token 510 in accordance with input from the input apparatus 436 by a service user (step 1350). If not to be registered, a corresponding message is output on the output apparatus 437 and the processing is terminated (step 1330). If to be registered, the certification authority certificate and the license information are sent to the in-token storage verification block 560, where the token identification number 810 is fetched from the token identification information storage region 571 in the storage block 570 (step 1360) and it is compared to the token identification number 930 in the license information to determine whether they coincide (step 1370). If they coincide, the certification authority certificate and the license are stored in the certification authority certificate and license information storage region 572 (step 1380). If they do not coincide, an error message is displayed on the output apparatus 437 and the processing is terminated (step 1330).

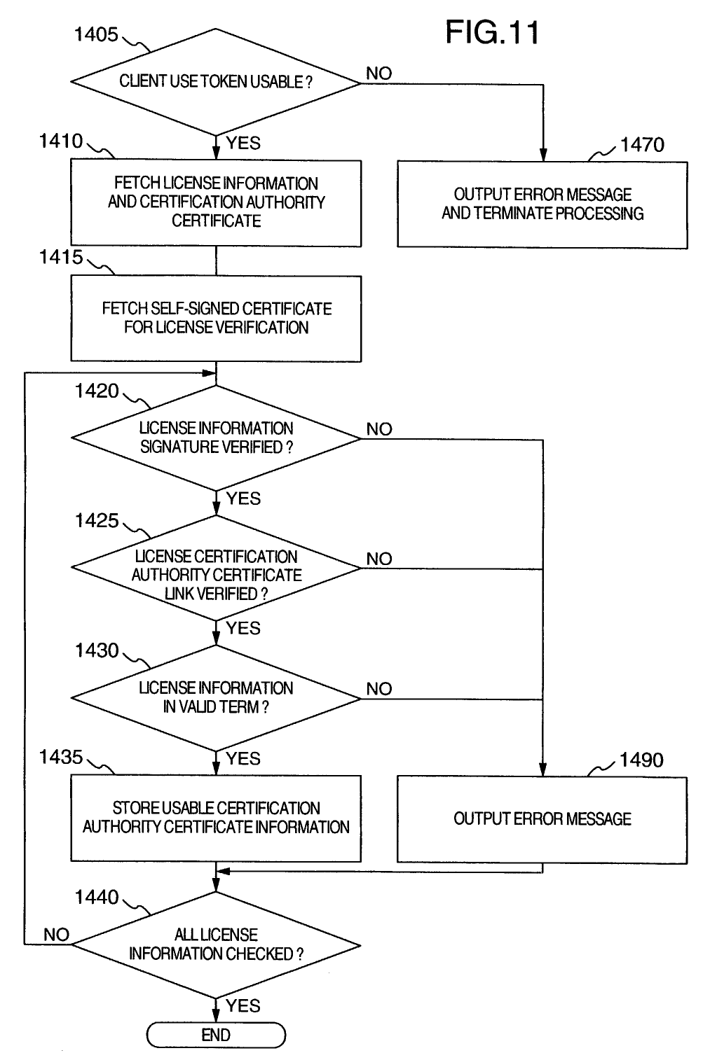

Next, explanation will be given on the processing of license information verification of the client system 400 with reference to a flowchart of FIG. 11. The usable information management block 435 monitor whether the client use token 510 is connected to the basic system 410 and can be used (step 1405). If the client use token 510 cannot be used, a corresponding message is displayed on the output apparatus 437 and the processing is terminated (step 1470). If the client use token 510 can be used, the license verification block 431 references a license information storage destination in the token stored in the token storage information reference destination information storage region 422, fetches all the license information and certification authority certificates stored in the certification authority certificate and license information storage region 572 (step 1410), and performs license information verification for a pair of certification authority certificate and license information as follows. A self-signed certificate for license verification is fetched from the license server self-signed certificate storage region 421 (step 1415) and signature verification is performed to determine whether the license information has been received from an authentic license server (step 1420). When the verification fails, an error message is output (step 1490) and if other license information is present, control is returned to step 1420, and if not, the processing is terminated (step 1440). Next, a hash value of the certification authority certificate is calculated and compared to the hash information 910 of the certification authority certificate stored in the license information to confirm linking with the license information (step 1425). When the hash values do not coincide, an error message is output (step 1490) and if other license information is present, control is returned to step 1420, and if not, the processing is terminated (step 1440). Next, the license valid term 920 is compared to a current time to determine whether the license is valid (step 1430). If the license is not valid, an error message is output (step 1490) and if other license information is present, control is returned to step 1420, and if not, the processing is terminated (step 1440). If the license is determined to be valid, information in the license information such as a certification authority certificate related to the license information and the license valid term is stored as usable certification authority certificate information in the usable certification authority certificate information temporary storage region 423 (step 1435) and if other license information is present, control is returned to step 1420 and if not, the processing is terminated (step 1440).

It should be noted that what is stored in the usable certification authority certificate information temporary storage region 423 maybe only a certification authority certificate or both of certification authority certificate and license information according to an embodiment.

FIG. 5 shows data configuration of information 522 in the usable certification authority certificate information temporary storage region. In the present embodiment, the information 522 includes a certification authority certificate 1001, a license end time 1002 indicating the usable term of the certification authority certificate, and connection destination information 1003 indicating a usable destination of the certification authority certificate. Thus, by storing the license end time 1002 and the connection destination information 1003 together with the certification authority certificate 1001, it is possible to improve the connection verification efficiency of the client system 400 at service use as will be detailed later.

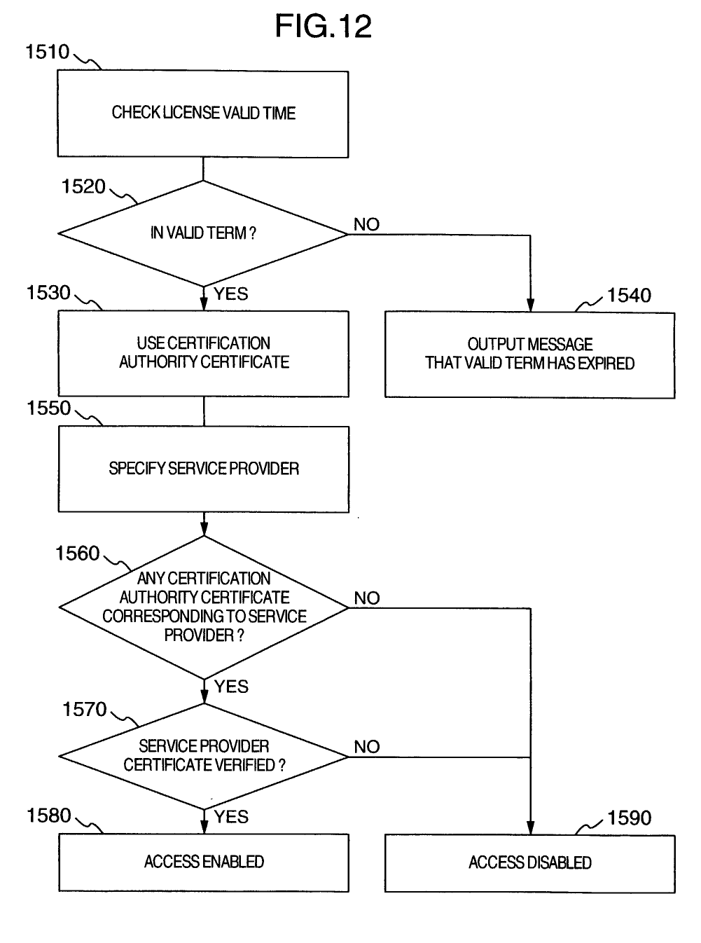

Explanation will be given on the processing of the client system 400 at service use with reference to a flowchart of FIG. 12. The license verification block 431 verifies whether the license end time 1002 exceeds the current time when using the certification authority certificate 1001 (step 1510, step 1520). If the current time is exceeded, a message indicating that the license valid time has expired is output and the processing is terminated, thereby inhibiting use of the certification authority certificate (step 1540). Thus, the certification authority certificate can be used only in the license valid term (step 1530). By performing this processing, it is possible to prevent use of a certification authority certificate whose license valid term has expired while stored in the usable certification authority certificate information temporary storage region 423.

Next, the connection control block 432 specifies a service provider from an URL or the like stored in the service provider certificate transmitted from the service provider 300 (step 1550) and judges whether a usable certification authority certificate having the connection destination information 1003 corresponding to the specified service provider exists (step 1560). If a usable certification authority certificate exists, a service provider certificate is verified by using the certification authority certificate (step 1570). If the verification results in that the service provider certificate is authentic, the service provider can be accessed (step 1580). When a usable certification authority certificate is absent or when the service provider certificate is found not authentic, access is disabled (step 1590).

By performing such processing, it is possible to limit use of a certification authority certificate on a connection destination basis (service basis).

It should be noted that the verification of the license valid term of the certification authority certificate by the license verification block 431 and the verification of the service provider certificate by the connection control block 432 may be performed in a different order according to an embodiment. In this case, the service provider certificate is verified by using a predetermined certification authority certificate and after this, the valid term of the certification authority certificate which has performed verification is verified. If the certification authority certificate which has performed verification is within a valid term, access to the service provider is enabled. Moreover, a part of the processing may be omitted according to an embodiment.

Moreover, the certification authority certificate 1001 in the usable certification authority certificate information temporary storage region 423 can also be used for a certificate verification upon establishing an SSL communication with the service provider 300 like the current WWW browser. If there is no certification authority certificate liked to the service provider digital certificate (server certificate), the certificate verification fails and service use cannot be performed from the client system 400.

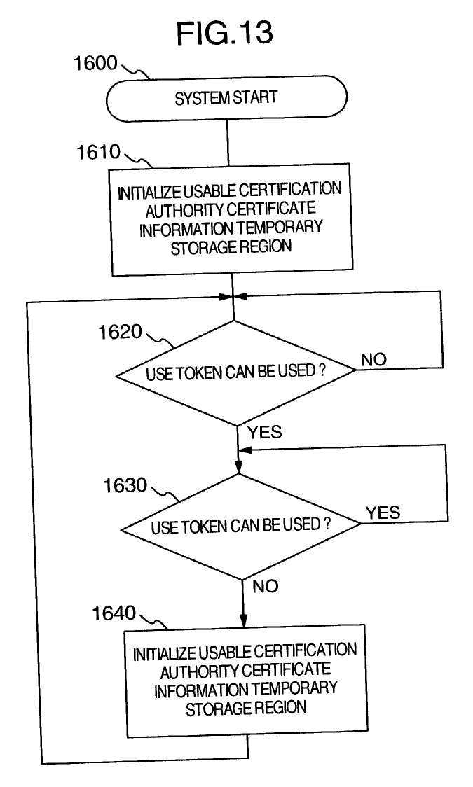

FIG. 13 is a flowchart of state monitoring about a use token of the usable information management block 435. Upon start of the basic system 410 (step 1600), the usable information management block 435 erases information in the usable certification authority certificate use information temporary storage region 423 (step 1610). After this, monitoring is continued to check whether the use token can be used (step 1620). After detecting that the token can be used, monitoring is continued to check whether the token has become unusable (step 1630). When the token has become unusable when the use token is removed from the basis system or by other reason, the information in the usable certification authority certificate use information temporary storage region 423 is erased (step 1640) and control is returned to step 1620.

In the aforementioned embodiment, the client system is divided into the basic system and the client use token but they can be a unitary block without departing from the object of the present invention.

Moreover, in the aforementioned embodiment, all the license information items are simultaneously verified at the license information verification. However, it is also possible to verify license information related to a certification authority certificate upon actual use of the certification authority certificate.

Moreover, in the aforementioned embodiment, a certification authority certificate and related license information are received from the license server. However, it is also possible that the certification authority certificate is contained in the client system storage block and only the license information is received from the license server.

Moreover, in the aforementioned embodiment, a certification authority certificate is related to license information by adding hash information of the certification authority certificate to the license information. However, it is possible to use other information capable of relating them such as a serial number of the certificate.

According to the embodiment of the present invention, in a general-purpose system, it is possible to realize client system use limit for each service only by control of the client side. This reduces the load of the server side. Moreover, it is possible to easily add a service which can be used by using the general-purpose system, by adding a certification authority certificate and license information of the object. Moreover, since a user approves to add a certification authority digital certificate, it is possible to use by limiting only to a necessary service. Moreover, as compared to access control by a server using a client certificate transmitted from a general-purpose client system, a client certificate can be fetched easily and it is possible to realize license management having a high anonymity.

According to the present invention, access control to a service provider can be performed service user side. Moreover, it is possible to flexibly perform use limit for each service.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An access control method for controlling access to a first system connected to a second system via a network, the method comprising:
managing first information used to determine whether the first system has right to access the second system;
receiving second information transmitted from the first system when the first system is accessed, said second information making the first information into a usable state under a predetermined condition;
determining whether first information is corresponding to the second information in the usable state;
verifying the second information by using the first information, if one is in the usable state; and
allowing access to the first system in accordance with the verification result.

2. The access control method according to claim 1, wherein
the predetermined condition relates to a valid term of the first information; and
when a condition related to the valid term is satisfied, the first information is made into the usable state.

3. The access control method according to claim 1, wherein
the first information is a certification authority certificate identifying a certification authority; and
the second information is a certificate issued from the certification authority and specifying the first system to which authentication of the certification authority is added.

4. The access control method according to claim 1, wherein
a public key of the certification authority is added to the first information; and
the second information is digitally signed with a secret key of the certification authority.

5. An access control method used in a client connected via a network to a service provider server and to a license server issuing a certification authority certificate enabling service use of the service provider server and license information indicating a use condition of the certification authority certificate, the method comprising:
storing the certification authority certificate and the license information transmitted from the license server, in a first storage block detachable from a basic system;
when the first storage block is connected to the basic system, verifying whether the certification authority certificate can be used by reading out the certification authority certificate and the license information from the first storage block;
storing the certification authority certificate in a second storage block in the basic system in accordance with the verification result;
determining whether a service of the service provider server can be used by using the certification authority certificate stored in the second storage block; and
deleting the certification authority certificate from the second storage block when the first storage block is not connected to the basic system.

6. The access control method according to claim 5, wherein the first storage block has a uniquely defined identification number; and
when this identification number coincides with an identification number described in the license information, the certification authority certificate and the license information are stored in the first storage block.

7. The access control method according to claim 5, wherein verification of usability of the certification authority certificate read out from the first storage block is performed by using a valid term described in the license information.

8. The access control method according to claim 5, wherein verification of usability of the certification authority certificate read out from the first storage block is performed by using connection destination information described in the license information.

9. An access control system used in a client connected via a network to a service provider server, the system comprising:
license verification means for verifying whether the certification authority certificate can be used by using a certification authority certificate enabling use of service of the server and a license information indicating a use condition of the certification authority certificate;
storage means for storing the certification authority certificate which has been determined to be usable by the license verification means; and
connection control means for determining whether the service use of the server is allowed by using a service provider certificate transmitted from the server upon access to the server and the certification authority certificate stored in the storage block.

10. The access control system according to claim 9, wherein the license information includes information for limiting a valid term of the certification authority certificate and use of the certification authority certificate on server basis.

11. The access control system according to claim 9, wherein when the certification authority certificate is stored in the storage means and when the certification authority certificate is used, the license verification means checks a valid term described in the license information, thereby verifying whether the certification authority certificate can be used.

12. The access control system according to claim 9, the system further comprising management means for deleting the certification authority certificate under a predetermined condition.

13. The access control system according to claim 9, wherein the license information includes connection destination information to be used when performing connection to the server.

14. The access control system according to claim 13, wherein the license verification means verifies whether the certification authority certificate can be used in accordance with the connection destination information stored in the license information.
